(19) United States
(12) Patent Application Publication
(10) Pub. No.: US 2004/0099703 A1
(43) Pub. Date: May 27, 2004

(54) Contoured cargo tray

(76) Inventor: James Lawrence Schoenberger, Sun Prairie, WI (US)

Correspondence Address: GODFREY & KAHN S.C., 780 NORTH WATER STREET, MILWAUKEE, WI, 53202, US

(21) Appl. No.: 10/304,532

(22) Filed: Nov. 26, 2002

(51) Int. Cl. B60R 7/00; B60R 9/00

(52) U.S. Cl. 224/401

(57) ABSTRACT

A contoured cargo tray is attachable to an All Terrain Vehicle (“ATV”) or other vehicle. The contoured cargo tray has an open receptacle area that can be formed so as to accommodate a variety of articles such as buckets, boxes, bags, and the like. The contoured cargo tray may also provide for a tool holder where tools are inserted into and held by slots or a trench.

### BACKGROUND OF THE INVENTION

This invention relates generally to article receptacles that can be attached to an vehicles. Specifically, this invention relates to cargo trays, and in particular to a cargo tray that is contoured to securely hold objects, that are attachable to all-terrain vehicles (ATVs).

Hunters, fishers, campers, and outdoorsman have been using tools and buckets in their endeavors for a great many years. Large buckets provide an easy storage and carrying container for a variety of objects. The availability of large, inexpensive plastic buckets has increased the use of these buckets in connection with outdoor activities. The buckets may be used to carry tools, clothing, supplies, or other various articles. In addition, the buckets may also be used to hold dirty, messy, or wet objects such as live or dead fish, bait, soiled clothing, or the like. Once the user returns to a campsite or home, a simple spray of the bucket with water sufficiently cleans the bucket so that it may be used for a number of purposes again. If the bucket cracks or breaks, it is easily replaced at little expense. For all these reasons and more, large buckets are frequently used in transporting articles in connection with a wide variety of outdoor activities.

The use of ATVs in connection with outdoor activities has also increased in recent years. These vehicles allow users to explore new areas and visit spots that are unreachable by foot. Forests and dunes have become popular areas of exploration by ATV. To aid these users, a variety of ATV accessories have been developed that allow the user to carry gear, weapons, tools, food and such easily on an ATV. Coolers, luggage, cargo bags, nets, boxes, and brackets for weapon cases and tools that easily attach to ATVs have been developed. Despite all these available accessories, riders of ATVs still frequently use buckets as all-purpose storage and carrying containers. These users typically attempt to either balance the buckets on an ATV, tie the buckets to an ATV with rope or bungee cords, or squeeze the buckets into an available ATV accessory. Such efforts produce less than ideal results because the buckets cannot be easily or securely attached to an ATV. The round shape and plastic construction of the buckets and often wet conditions lead to buckets sliding off of ATVs or their moving uncontrollably around on an ATV rack. Couple this sliding and movement with rather fast speeds and bumpy terrain common to ATV usage and the result is the contents of the buckets are strewn about the forest or dune.

In addition to the fact the current ATV accessories cannot adequately hold buckets, separate accessories are needed to hold cargo and large tools. Further, the storage accessories generally available typically have closing lids. Such designs limit the availability of the ATV rider to quickly access gear, tools, and such stored in these accessories.

It is thus desirable to have a container for cargo that easily attaches to an ATV, that can securely hold large buckets, simultaneously hold large tools, and has an open top for easy access to the cargo. Of course, the present invention may be used in a multitude of non-ATV environments and installations where similar performance capabilities are required.

### SUMMARY OF THE INVENTION

The present invention provides a contoured cargo tray that is cost-effective, easily attached to an ATV where it is securely retained, provides an improved ability to transport cargo including conventionally-shaped five gallon buckets, and which solves the problems raised or not solved by existing designs.

The contoured cargo tray has an open top so that articles stored in the tray can be easily accessed. The contoured cargo tray may be designed and contoured so as to provide an open receptacle area that can accommodate shaped articles such as five gallon buckets. The shape of the tray allows it to securely hold these articles. Such articles include, but are not limited to, five gallon buckets although other shapes may be designed. In addition, the tray may be configured to hold tools while also holding the shaped objects. To accomplish this, a tool holder may be integrated into the tray.

One embodiment of the invention includes a tool holder that is integrated with the contoured cargo try and attaches to the vehicle. Alternatively, the tool holder may be a separate accessory. The tool holder may take the form of a series of slots or holes through which tools may be inserted. Alternatively, the tool holder may be a trough or groove in which tools may be secured.

While one possible application of the present invention is in connection with an ATV, use with other vehicles is possible and references to use in connection with an ATV should not be deemed to limit the uses of the present invention. The terms “contour,” attachment,” “tray,” or “open receptacle area” as used herein should not be interpreted as being limited to specific forms or shapes of contour, attachment, tray, open receptacle area, or interior space. Rather, the contour, attachment, tray, and open receptacle area of the contoured cargo tray may have a wide variety of shapes. These and other objects and advantages of the present invention will become apparent from the detailed description, claims, and accompanying drawings.

### DESCRIPTION OF THE DRAWINGS

FIG. 1 is a perspective view of a contoured cargo tray in accordance with one embodiment of the present invention;

FIG. 2 is a perspective view of a contoured cargo tray in accordance with one embodiment of the present invention, shown attached to an ATV with bungee cords, where the tray is holding two buckets;

FIG. 3 is a perspective view of a contoured cargo tray in accordance with one embodiment of the present invention, shown attached to the cargo rack of an ATV, where the tray is holding two buckets and three long handled tools;

FIG. 4 is a perspective view of a contoured cargo tray in accordance with one embodiment of the present invention, shown attached to the cargo rack of an ATV, where the tray is holding two buckets and a long handled tool;

FIG. 5 is a perspective view of a contoured cargo tray in accordance with one embodiment of the present invention, shown attached to the cargo rack of an ATV where the tray is holding two buckets and a hard sided gun case;

FIG. 6 is a perspective view of a contoured cargo tray in accordance with one embodiment of the present invention, shown attached to an ATV, where the tray is attached by bungee cords; and

FIG. 7 is a partial cross sectional view of a contoured cargo tray in accordance with one embodiment of the present invention, shown attached to an ATV by U-bolts.

### DETAILED DESCRIPTION OF THE PREFERRED EMBODIMENTS

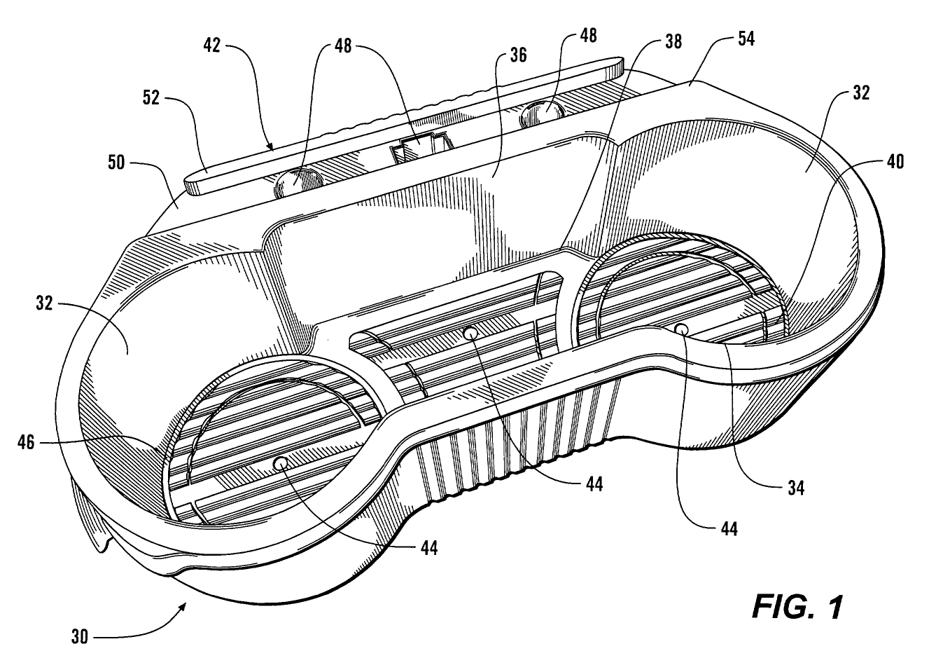

Illustrative embodiments of a contoured cargo tray (identified generally as 30) in accordance with the present invention are shown in FIGS. 1 through 7. While the invention may be susceptible to embodiment in different forms, there is shown in the drawings, and herein will be described in detail, certain illustrative embodiments with the understanding that the present disclosure is to be considered an exemplification of the principles of the invention, and is not intended to limit the invention to those embodiments illustrated and described herein. Additionally, features illustrated and described with respect to one embodiment could be used in connection with other embodiments.

Generally, the contoured cargo tray 30 has a front wall 34, side walls 32, a back wall 36, and a floor 40. These parts are formed together so as to define an open receptacle area 38. The contoured cargo tray 30 may be constructed of a resilient material such as plastic or metal. Preferably, this material is non-corrosive. If the contoured cargo tray 30 is made of plastic, it may be manufactured by rota molding, injection molding, blow molding, casting, or other process. Regardless of the material and manufacturing process used, the contoured cargo tray 30 may be constructed out of a single piece of material. Alternatively, each part may be a separate piece with the pieces connected by glue, welds, hinges, solder, or any other method.

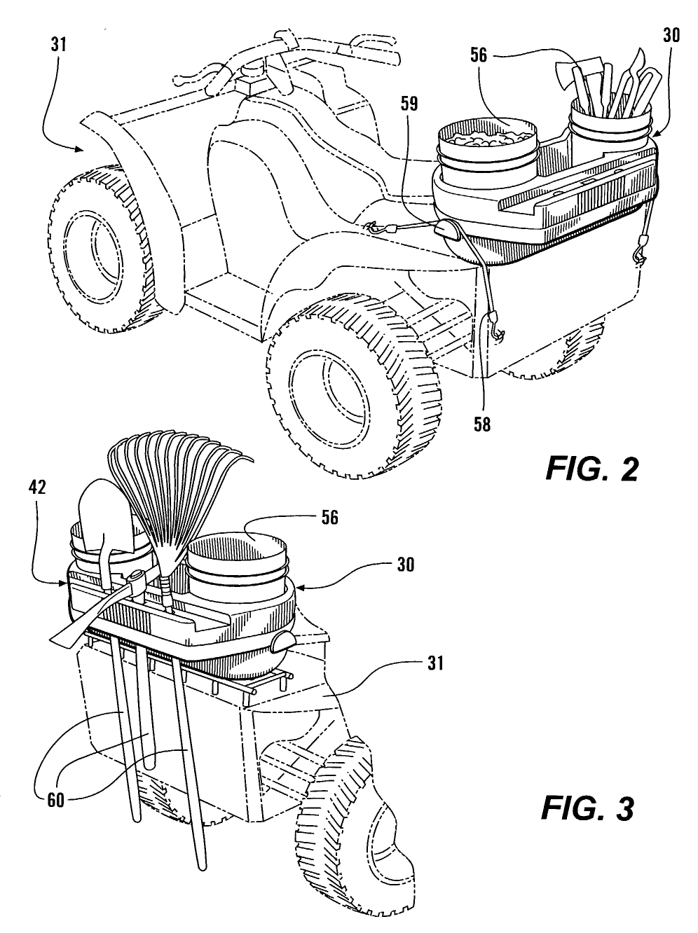

The contoured cargo tray 30 is designed so as to be attachable to an ATV 31 as shown in FIGS. 2-7. The open receptacle area 38 is shown in FIG. 1. In the embodiment shown in FIG. 1, the open receptacle area 38 is defined so as to accommodate and securely hold two buckets 56 as is shown in FIGS. 2-6. The floor 40 of the contoured cargo tray 30 may have a series of strengthening ribs or ridges 46. The ribs 46 have numerous purposes. One purpose is to provide for improved durability of the floor 40 specifically and the contoured cargo tray 30 generally. A second purpose is to channel water, mud, and other liquid in the contoured cargo tray 30 towards the holes 44 in the floor 40. A third purpose is to provide a rough surfaces that increase the ability of the contoured cargo tray to securely hold articles by providing an higher coefficient of friction between the floor 40 and the article or bucket 56. Such friction, along with the shape of the open receptacle area 38, prevents the article or bucket 56 from sliding on the floor 40 while the ATV 31 is in motion. Ribs 44 may also be provided on the side wall 32, front wall 34, or back wall 36 (not shown).

As shown in FIG. 1, the floor 40 may have a single or series of holes 44. The holes 44 provide drainage for the contoured cargo tray 30 or provide a place whereby the contoured cargo tray 30 can be bolted to the ATV 31 as is explained below. Water, dirt, and mud are commonly encountered while driving ATVs 31 and ATVs 31 are often driven through wet environments. Further, articles transported in the contoured cargo tray 30 may be wet. In one embodiment, buckets 56 are transported inside the contoured cargo tray 30. The buckets 56 may be filled with water, mud, cement, paint, or any number of liquids. ATVs 31 are also often driven over uneven and off-road surfaces. Many bumps are encountered. As such, the ATV 31 and attached contoured cargo tray 30 may be jostled resulting in liquid in the buckets 56 being spilled inside the contoured cargo tray 30. Further, ATVs 31 are also stored outdoors. During a rainstorm, water may accumulate in the contoured cargo tray 30. Regardless of the means by which it became present, liquid is routinely present in the contoured cargo tray 30. The holes 44 provide drainage so that the liquid does not pool in the contoured cargo tray 30.

As shown in FIGS. 2-7, the contoured cargo tray 30 may be attached to an ATV 31 or other vehicle. Many different methods may be used to accomplish this attachment. One such method involves using bungee cord, rope, cord, or other tie 58. The contoured cargo tray 30 may have a series of hooking posts 59. These hooking posts 59 may be of the same piece of material as the contoured cargo tray 30 or may be separate pieces. The hooking posts 59 may be formed of plastic, metal, or other durable material.

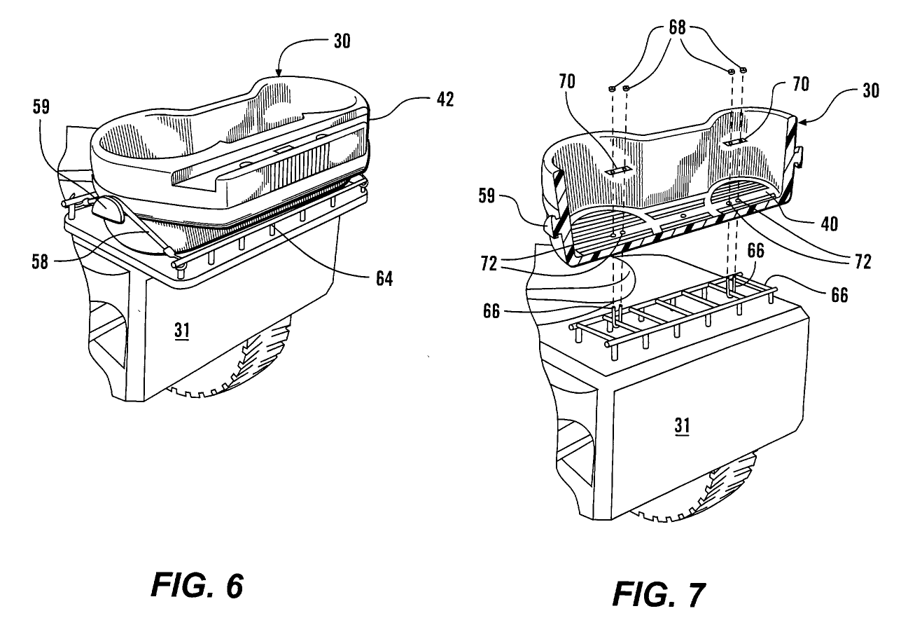

As shown in FIG. 6, the tie 58 may be attached at one end to a rack 64 on an ATV 31. The tie 58 is then run over the hook 59. The other end of the tie 58 is then secured to a portion of the rack 64 opposite the first attachment point. The tie 58 is attached so that tension is generated as the tie 58 engages the hooking post 59. This tension prevents the contoured cargo tray from disengaging from the ATV 31 while the ATV 31 is operated. Alternatively, as shown in FIG. 2, the ties 59 may be attached to points directly on the ATV 31. In addition, the hooking posts 59 may be designed to function as handles. An individual may carry the contoured cargo tray 30 by grasping the hooking posts 59.

Another method of attaching the contoured cargo tray 30, shown in FIG. 7, involves using a U-bolt bracket system. In this embodiment, additional holes 72 are provided for in the floor 40 of the contoured cargo tray 30. U-bolts 66 are passed around a portion of the rack 64. The contoured cargo tray 30 is fit onto the rack 64 so that the U-bolts 66 pass through the additional holes 72. A base plate 70 is then fit over the ends of the U-bolts 66. Fasteners 68 such as nuts or the like are attached to the ends of the U-bolts 66, thereby securing the base plate 70 to the floor 40 of the contoured cargo tray 30. The interaction of the contoured cargo tray 30 with the U-bolt bracket system and the rack 64 functions to securely attach the contoured cargo tray 30 to the ATV 31 so that the contoured cargo tray 30 does not disengage from the ATV 31 while the ATV 31 is operated. Alternatively, straight bolts that are adapted to secure the contoured cargo tray 30 to the ATV 31 or the rack 64 of the ATV 31 may be used.

One embodiment of the invention also provides a tool holder 42. As shown in FIGS. 1-6, the tool holder 42 may be an integrated part of the contoured cargo tray 30. The tool holder 42 may be formed of any durable material, such as plastic or metal, and manufactured using any number of methods such as injection or blow molding or casting. The tool holder 42 may be formed of the same piece of material as the contoured cargo tray 30 or may be a separate piece that is attached to the contoured cargo tray 30. In one embodiment, shown in FIG. 1, the tool holder 42 has a series of slots or holes 48. These slots 48 are designed to accommodate and securely hold long handled tools 60 as shown in FIG. 3. Tools 60 are inserted vertically through the slots 48. As shown in FIG. 5, these slots may also be designed to accommodate additional mounting and bracketing devices including but not limited to gun case grips, gun case holders, gun case brackets, and tool brackets such as the ones disclosed in U.S. Pat. Nos. D454,479 and D442,454, the disclosures of which are incorporated herein by reference. The slots 48 may be riveted and threaded so that these devices may be attached to the tool holder 42 by screwing the device into the slots 48. Alternatively, the slot 48 may be configured so that other devices may be snap-fit into the slots 48 or otherwise attached to the tool holder 42. As such, these mounting and bracketing devices could be attached to the tool holder 42 which is in turn attached to the ATV 31 to allow the secure holding of a wide variety of equipment.

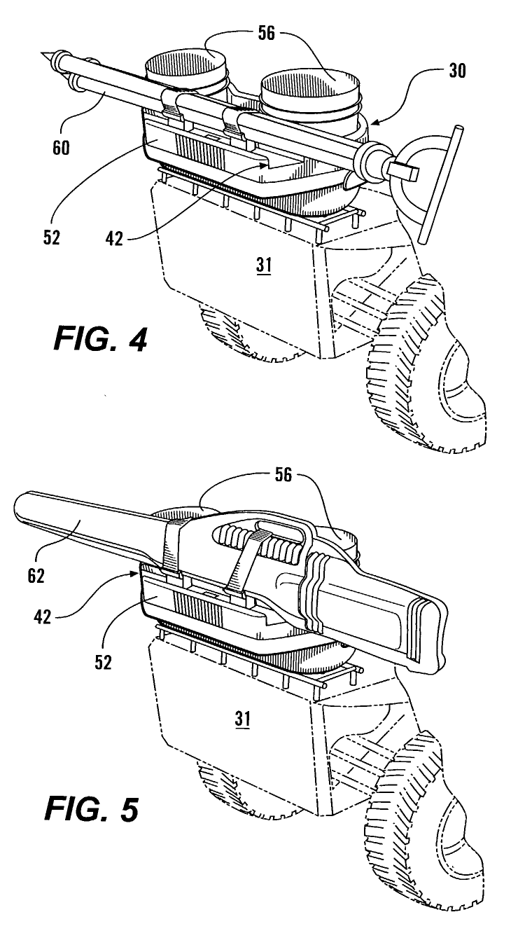

As best shown in FIGS. 1, and 4, the tool holder 42 may also have a trench 50. This trench 50 may be formed between the rear lip of the tool holder 52 and the lip 54 of the contoured cargo tray 30 or the another lip of the tool holder 42. This trench 50 is designed to accommodate and securely hold long tools 60 as shown in FIG. 4. Tools 60 may be inserted horizontally into the trench 50 and strapped down or otherwise secured in the trench 50. Alternatively, the trench 50 may be designed to accommodate and securely hold gun cases. Gun cases may include hard-sided gun cases such as the ones disclosed in U.S. Pat. Nos. D421,179 and D309,675, the disclosures of which are incorporated herein by reference.

It is possible to alter the design of the contoured cargo tray 30 without departing from the invention. For example, one portion of the open receptacle area 38 may be contoured so as to accommodate and securely hold a bucket 56 while the other portion has a different shape. That other portion may be square, triangular, contoured to hold a tackle box, cooler, luggage, gear box, cargo bag, or any other shape. The entire open receptacle area 38 may be contoured to hold any variety of article such as a tackle box, cooler, luggage, gear box, cargo bag, or any shaped article. The open receptacle area 38 may be dimensioned and contoured so as to accommodate and securely hold one, two, three, four, or any number of buckets 56. The buckets 56 may be of the same or different shape. The contoured cargo tray 30 may also be designed to have a series of recesses to hold tools independent of the tool holder 42 or trench 50.

Although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims.

I claim:

1. An article receptacle for attachment to a vehicle comprising;
a body having a front wall and a back wall connected by side walls, wherein the front wall, back wall, and side walls are attached to a floor to define an open receptacle area, the article receptacle area being dimensioned so as to accommodate at least one article; and,
a tool holder attached to the body wherein at least one tool may be secured.

2. The article receptacle of claim 1, wherein the open receptacle area is contoured to hold at least one bucket.

3. The article receptacle of claim 1, wherein the floor has at least one drainage hole.

4. The article receptacle of claim 1, wherein the floor has a plurality of ribs.

5. The article receptacle of claim 1, further comprising slots in the body through which accessories are attached to the article receptacle.

6. The article receptacle of claim 1, wherein the tool holder comprises a plurality of slots into which tools may be inserted.

7. The article receptacle of claim 1, wherein the tool holder comprises a trench in which tools may be secured.

8. The article receptacle of claim 1, further comprising at least one hooking post by which the article receptacle may be attached to a vehicle.

9. The article receptacle of claim 1, further comprising at least one hole in the floor through which the article receptacle may be bolted to a vehicle.

10. The article receptacle of claim 8, further comprising a cord which communicated with the hooking post so as to attach the article receptacle to the vehicle.

11. A contoured cargo tray for attachment to a vehicle comprising:
a main body including an open receptacle area, the open receptacle area formed by a plurality of walls and a floor and dimensioned to accommodate at least one article; and
means for attaching the main body to the vehicle.

12. The contoured cargo tray of claim 11 wherein the means for attaching the main body to the vehicle comprises at least one hooking post which is capable of communicating with a securing cord that is attached to the vehicle.

13. The contoured cargo tray of claim 11 wherein the means for attaching the main body to the vehicle comprises at least one bolt that passes through the floor of the main body and is attached to the vehicle.

14. A contoured cargo tray for attachment to a vehicle comprising:
an open securement area formed by a plurality of walls and a floor, the plurality of walls and floor formed as a unitary main body, the open securement area dimensioned to accommodate at least one bucket therein;
a tool holder formed as part of the unitary main body, the tool holder having at least one hole therein through which tools may be disposed; and
at least one hole in the floor of the unitary main body, the hole dimensioned so as to allow drainage of the open securement area therethrough.

15. The contoured cargo tray of claim 14, further comprising a means to attach the contoured cargo tray to a vehicle.

16. The contoured cargo tray of claim 14, further comprising a least one hooking post by which the receptacle may be attached to a vehicle.

17. The contoured cargo tray of claim 16, further comprising a cord which communicates with the hooking post so as to attach the contoured cargo tray to the vehicle.

18. The contoured cargo tray of claim 14, further comprising a least one hole in the floor through which the contoured cargo tray may be bolted to a vehicle.
